(19) United States
(12) Patent Application Publication
(10) Pub. No.: US 2014/0110942 A1
(43) Pub. Date: Apr. 24, 2014

(54) Method and System for Improved Hydropower Generation in Existing Dams and Impoundments

(71) Applicants: Wayne F. Krouse, Mount Brook, AL (US); Mike Maley, Burr Ridge, IL (US)

(72) Inventors: Wayne F. Krouse, Mount Brook, AL (US); Mike Maley, Burr Ridge, IL (US)

(21) Appl. No.: 13/816,764

(22) PCT Filed: Nov. 14, 2012
(86) PCT No.: PCT/US12/64943

§ 371 Date: Feb. 13, 2013

Related U.S. Application Data
(60) Provisional application No. 61/569,982, filed on Dec. 13, 2011.

(51) Int. Cl. F03B 13/08; E02B 7/04

(52) U.S. Cl. CPC F03B 13/08; E02B 7/04
USPC 290/52; 60/639; 405/107

(57) ABSTRACT

A power generating system in a dam or impoundment where a section is removed by precision saw cutting to create a void or a base placed adjacent to the dame or impoundment is inserted for the mounting of a turbine frame with a plurality of power generating cells comprising a turbine and a generator and a second removed section to create voids for outlet draft tubes where the turbine frame is matably inserted in the first void, the turbines in said frame are positioned to permit water flow through the turbines and out the voids for outlet flow, and the turbines are operably engaged to a plurality of generators for generating power from the movement of water across the turbines. The cells may be mounted on top of a dam weir after precision removal to create a base and may have added draft tubes for water flow.

### CROSS REFERENCE TO RELATED APPLICATIONS

This application claims the benefit of U.S. Provisional Patent Application Ser. No. 61/569,982 filed Dec. 13, 2011 entitled “Method and System for Improved Hydropower Generation in Existing Dams” which is incorporated by reference as if fully set forth herein.

### BACKGROUND OF THE INVENTION

This invention relates generally to the field of power generation, and more particularly to a Method and System for Improved Hydropower Generation at Existing Dams and Impoundments.

### BRIEF SUMMARY OF THE INVENTION

The primary advantage of the invention is to provide improved hydropower extraction from existing dams and impoundments

Another advantage of the invention is to provide an insertable frame module or a plurality of power generating stackable cells for generation of power at existing dams and impoundments.

Another advantage of the invention is to provide a system for retrofitting existing dams and impoundments for insertion of power generating modules and draft tubes.

A further advantage of the invention is to provide a selectively activatable power generating module for utilization of head potential in an existing dams and impoundments.

Yet another advantage of the invention is to provide a method for placement of energy generating cells, stacks of cells and frames on an existing weir or within an existing concrete dam or impoundment structure.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view from the upper pool of a dam with an inserted power generating frame according to a preferred embodiment of the invention.

FIG. 2 is a perspective view from the lower pool of a dam with an inserted power generating frame according to a preferred embodiment of the invention.

FIG. 3 is a perspective view from the lower pool of a dam with carved out sections for insertion of a frame module including outlet draft tubes according to a preferred embodiment of the invention.

FIG. 4 is a plan view of a dam and planned removed portion on the upper pool side of the dam according to a preferred embodiment of the invention.

FIG. 5 is an elevation view of the downstream side of a reconfigured dam according to a preferred embodiment of the invention showing cross section 7-7.

FIG. 6 is an elevation view from the upper pool side of a reconfigured dam according to a preferred embodiment of the invention.

FIG. 7 is a cross sectional view of FIG. 5 along section 7-7 according to a preferred embodiment of the invention.

FIG. 8 is a cross sectional view of FIG. 1 along section 8-8 according to a preferred embodiment of the invention.

FIG. 9 is a top plan view of a preferred embodiment of the invention in situ at a dam configuration having locks, gates and a concrete structure carved out for placement of energy producing modules and frames and draft tubes.

FIG. 10 is an elevation view of a preferred embodiment showing an alternative preferred embodiment of the invention in situ at a configuration whereby energy producing frame modules are placed on a retrofitted concrete weir with associated draft tubes.

FIG. 10A is a side cross sectional view of a frame module and draft tube placed on a dam weir according to a preferred embodiment of the invention.

FIG. 10B is a side cross sectional view of a dam structure for removal of a portion and placement of a frame module according to a preferred embodiment of the invention.

FIG. 11A is a perspective view from an upper pool of a dam showing a platform according to an alternative preferred alternative embodiment of the invention.

FIG. 11B is a perspective view from an upper pool of a dam with an inserted power generating frame on a platform according to a preferred alternative embodiment of the invention.

FIG. 11C is a cross sectional view of FIG. 11A along section 11-11 according to a preferred alternative embodiment of the invention view.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

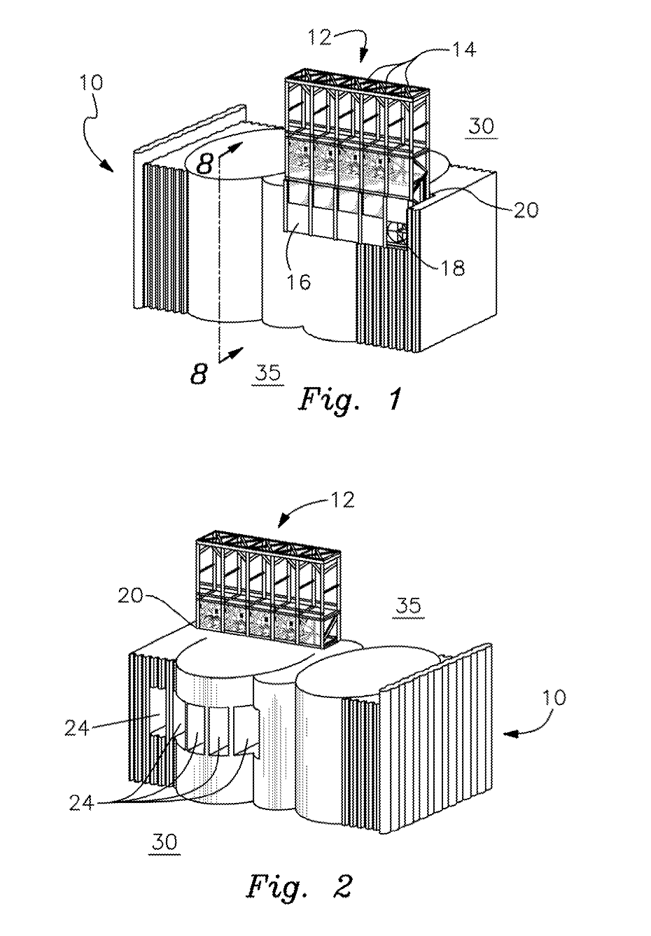

FIG. 1 shows a perspective view from an upper pool 35 of a dam 10 with an inserted power generating frame 12 with stackable cells 14 according to a preferred embodiment of the invention. Frame 12 has a plurality of cells 14 inserted into a cut out portion 20 of an existing dam structure. Frame 12 has stackable cells 14 each having turbine modules 18 positioned at the bottom of the frame each having a moveable door 16 that permits water flow across the turbine. The turbines are operably connected to a generator module that sits above the turbine to receive power from the rotating turbine. A superstructure portion of the frame further described below permits insertion and removal of modules comprising an energy generating cell of a turbine and generator. FIG. 1 shows a cross section 8-8 further described along with FIG. 8.

FIG. 2 is a perspective view from lower pool 30 of a dam with an inserted power generating frame 12 according to a preferred embodiment of the invention. Dam 10 has been cut to permit water flow through the dam in individual ducts 24 as further described.

FIG. 3 shows a perspective view from lower pool 30 of dam 10 with cut out section 20 for insertion of a frame module including outlet draft tubes 24 according to a preferred embodiment of the invention. The dam has been hollowed out on the upper pool 35 to receive frame 12 shown in FIGS. 1 and 2. On lower pool 30, outlet draft tubes 24 have been cut into the concrete of the dam to permit water flow through each turbine. Outlet draft tubes 24 may be of any of a variety of configurations but preferably are generally pyramidal and taper to a generally rounded opening that mates with the turbine outflow. In some alternative configurations, the draft tube may begin in a circular form to create a cone or transition from circular to other shapes, including oval, elliptical, rectangular, or any other regular or irregular geometric shape.

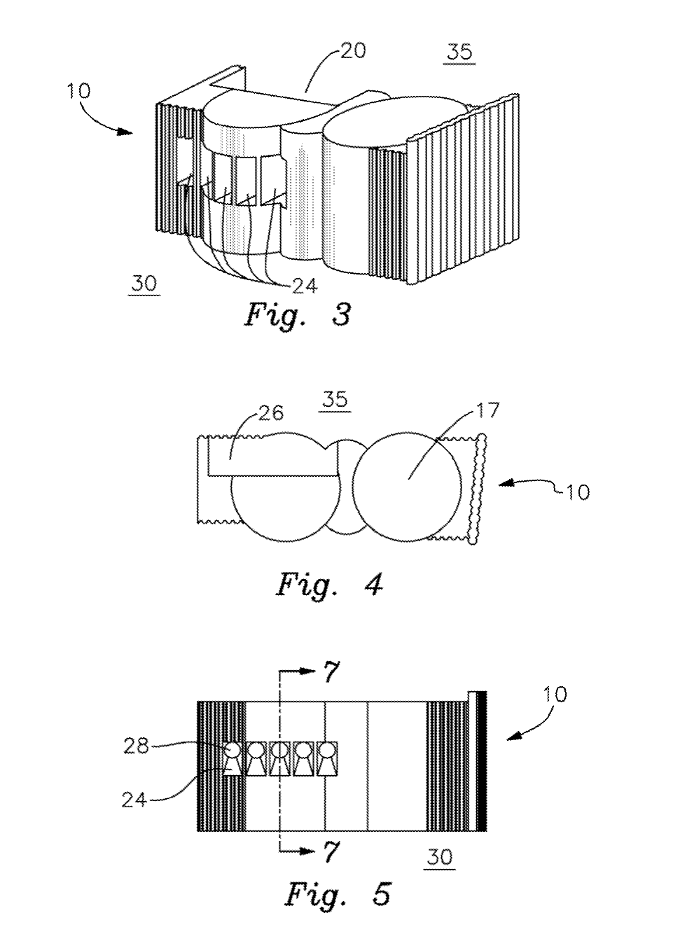

FIG. 4 is a plan view of dam 10 and selected portion 26 on upper pool 35 of the dam according to a preferred embodiment of the invention. Portion 26 may be cut away using various conventional concrete cutting, grinding or other removal techniques for precision cutting. The selected portion is configured to be approximately the same dimension and size as frame 12 so as to insert the module from above or from the upper pool side of dam 10. Top 17 of dam 10 may be used to mount a superstructure or gantry for lowering into position individual turbine modules or the entire frame 12 as needed.

FIG. 5 is an elevation view from lower pool 30 of dam 10 after the cutting away of the concrete to form outlet draft tubes 24 for each turbine module according to a preferred embodiment of the invention showing cross section 7-7. FIG. 5 shows an elevation view from the lower pool of outlet draft tubes 24 which in this embodiment flare outward from the more right cylindrical cut out 28 positioned adjacent the turbine and frame modules. Outlet draft tubes 24 as more fully shown in cross section in FIG. 7 have one end that is circular that meets the output of each turbine and another end that is rectilinear that places water in the lower pool 30.

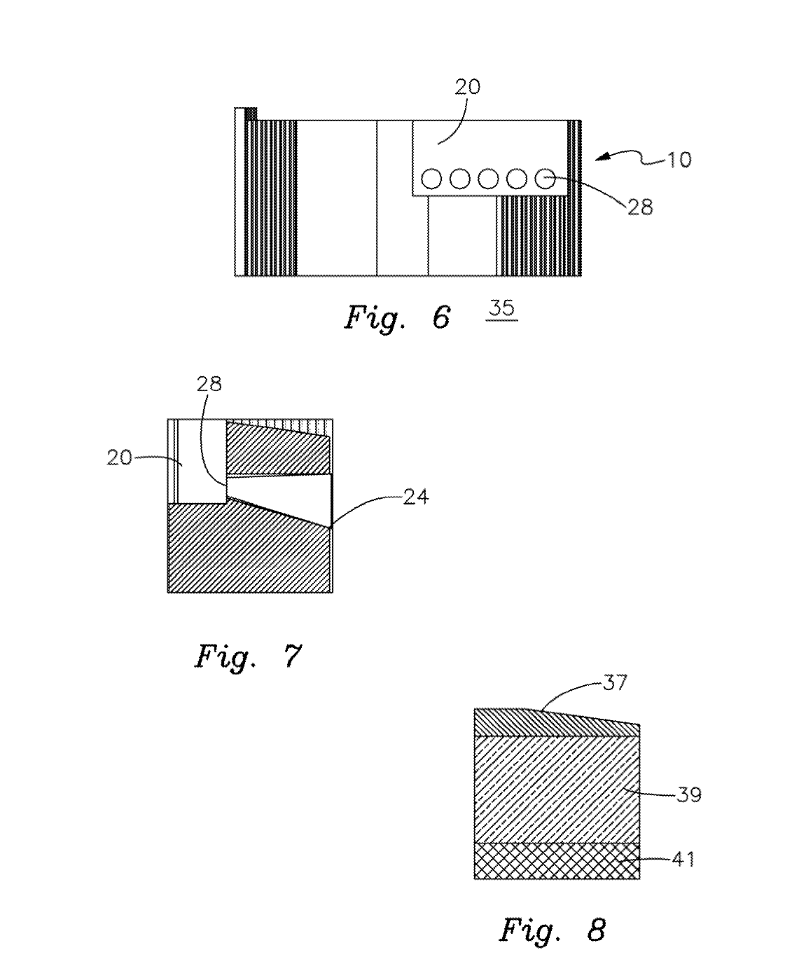

FIG. 6 shows an elevation view from upper pool 35 of the draft tubes which begin as right cylindrical cut out 28 and flare outward to pyramidal outlet tubes more fully shown in FIG. 7 in side view. A portion of the outflow tube may be a frusto-pyramidal shape having any of a variety of configuration including one with a right angle on one side and a sloping angle on the other as shown in FIG. 7 in cross section. Alternatively, draft tubes may be frusto-conical and maintain a generally circular cross section across the tube. Cut out portion 20 is shown in side elevation view and would support frame 12 and its insertion into the void created by cutting away the concrete and other materials in dam 10.

Through the use of innovative concrete precision cutting and grinding techniques, portions of concrete may be removed from an existing structure in desired shapes and configurations. One example is diamond wire sawing allows for segmentation or modification of a concrete structure into any size or shape, including heavily reinforced rebar, concrete encased steel beams, steel encased concrete and steel embeds. Wire sawing is ideal for cutting mass concrete too large for other methods. Wire sawing applications can remove large sections of heavily reinforced concrete where work space is restricted and can be used under water. This method of concrete cutting offers advantages including no vibration, no dust and no disruption to neighboring operations reducing costly downtime. By cutting an existing structure, substantial time and money benefits are achieved in that the supporting structure and draft tubes are created by voids in the dam. This allows for insertion of a pre-manufactured modular frame that contains the energy producing cells, while using certain voids as draft tubes or areas to accept prefabricated draft tubes that can be grouted into place. Another cost effective option can be grinding with machines called “road headers.”

FIG. 7 shows a cross sectional view of FIG. 5 along section 7-7 according to a preferred embodiment of the invention. FIG. 7 shows the receiving position or cut out portion 20 for the frame which is preferably a rectilinear shelf that can support the, frame on the existing concrete and structure of the dam while at the same time lending foundational support to counteract tipping forces. Outlet draft tube 24 is then carved out of the dam so that the turbines may be positioned adjacent the opening of the draft tubes for efficient water flow.

FIG. 8 is a cross section view of FIG. 1 along section 8-8 according to a preferred embodiment of the invention. FIG. 8 shows the existing concrete configuration of an exemplary dam having a cellular coffer with a reinforced concrete cap 37 at the top, followed by tremie fill 39 on stabilized soil 41. This shows a form of dam that may be cut with previously described concrete cutting technology to create the receiving void for the frame and voids for the inlet and draft tubes according to the present invention.

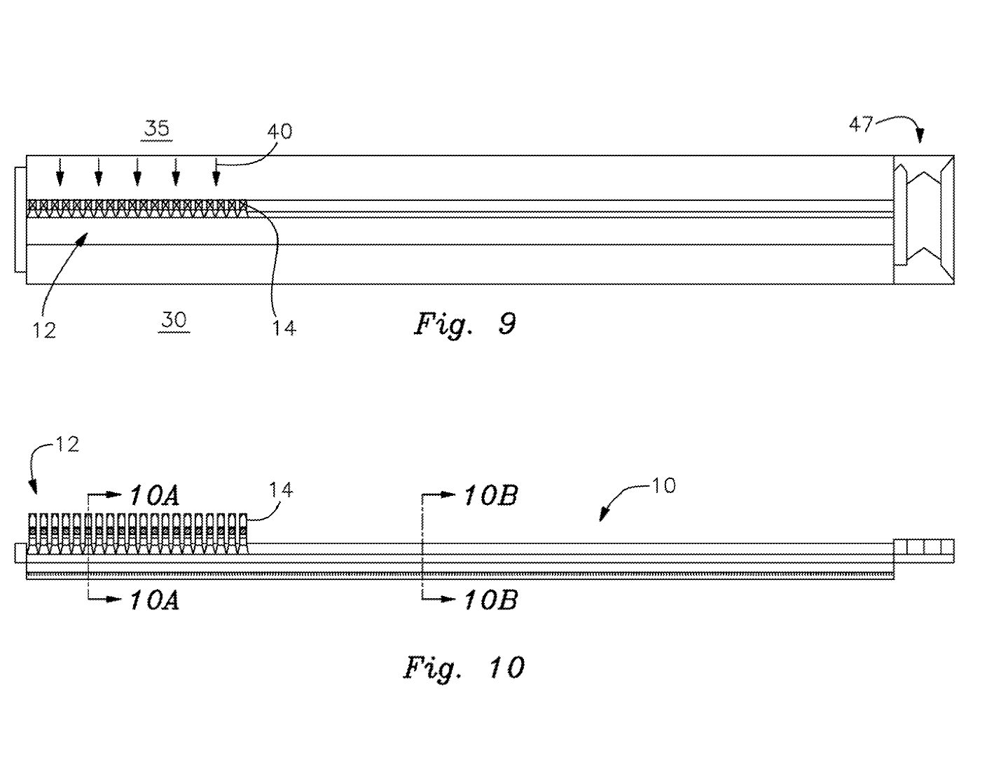

FIG. 9 shows an embodiment of the present invention in position and adjacent and exemplary fixed crest spillway, movable spillway containing tainter gates and lock and dam configuration 47. FIG. 9 shows a plan view of a lock and dam configuration 47 with added turbine/generator cells 14 in frame 12 placed within an existing dam as previously described with flow 40 from the upper pool 35. The frame may be composed of a plurality of power generating stackable cells having a turbine and generator pair for production of power.

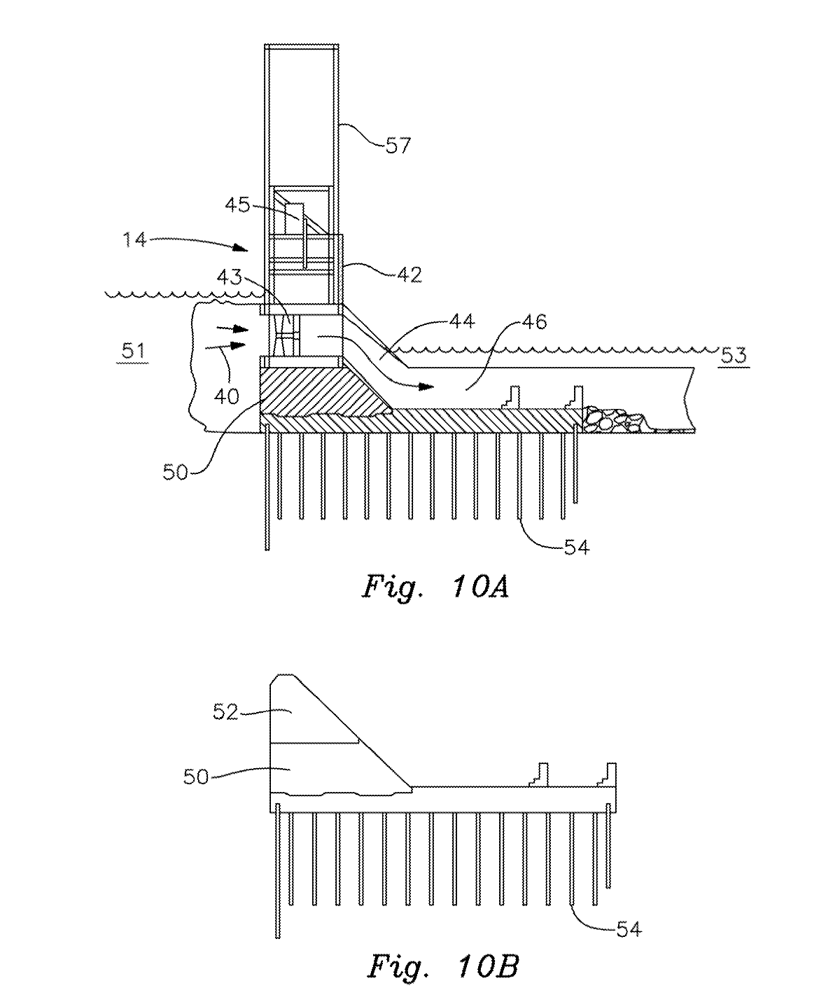

FIG. 10, and FIGS. 10A through 10B show another alternative embodiment of the present invention. FIG. 10 shows a solid concrete dam 10 of the fixed crest weir “ogee” type having generally triangular cross sectional structure and fixed crest weir, that may be cut to create a support for the frame by taking off the top of the weir and setting the frame on top of the flat area thereby using the existing dam as the foundation. Other cross sectional shapes may be present such as trapezoidal which may be retrofitted in similar fashion. FIG. 10 shows a plan view of the fixed crest weir with a plurality of turbine and generator cells 14 placed on top of the weir. The stacked modules having a turbine and generator are shown disconnected for illustrative purposes although in a preferred embodiment may be integrated into a unified frame having a plurality of cells as previously noted.

FIG. 10B is section 10B-10B of FIG. 10 shows the existing weir and triangular structure 52 for retrofitting and placement of the turbine/generator modules. As can be seen in FIG. 10B, the weir has been cut and a base support 50 created for reception of frame cells 14 shown in FIG. 10A. FIG. 10A shows the weir in side cross sectional view after being cut and after the frame has been installed on the dam.

FIG. 10A is section 10A-10A of FIG. 10 and shows a side cross sectional view of turbine/generator cells 14 that are mounted on the crest weir on triangular support 50 after being cut. These turbine/generators may be configured into a single frame and placed on the weir, or alternatively, may be individually inserted in place. Draft tubes 44 are positioned downstream of each turbine and, as shown in FIG. 10A, are configured to drop down into the lower water level behind the weir at 46 and are mounted above the existing dam structure with support piles 54 driven into the ground. On the upper pool side, a higher water level is present that creates head that in turn flows through the turbines to generate power. FIG. 10A shows a side cross sectional view of the existing crest weir with the higher water level 51 on the upper pool side than water level 53 the lower pool side.

After the weir is leveled off for reception of the frame, the energy producing cells composed of a turbine and generator are positioned on the base. Each module has its own door 42 for opening and closing the pathway through turbine 43 and has a draft tube 44 on the downstream side. As shown in FIG. 10A, each module has a turbine 43, a generator 45 operably connected via mechanical means, a door 42, a draft tube 44 and a superstructure 57 for facilitating placement and removal of the turbine and generator in modular stackable fashion. Power is aggregated among the plurality of energy producing cells and interconnected into the power grid.

Similar to the embodiment whereby voids are created in existing dam structures, innovative concrete precision cutting is used to level off the weir and make a platform for placement of the energy producing cells.

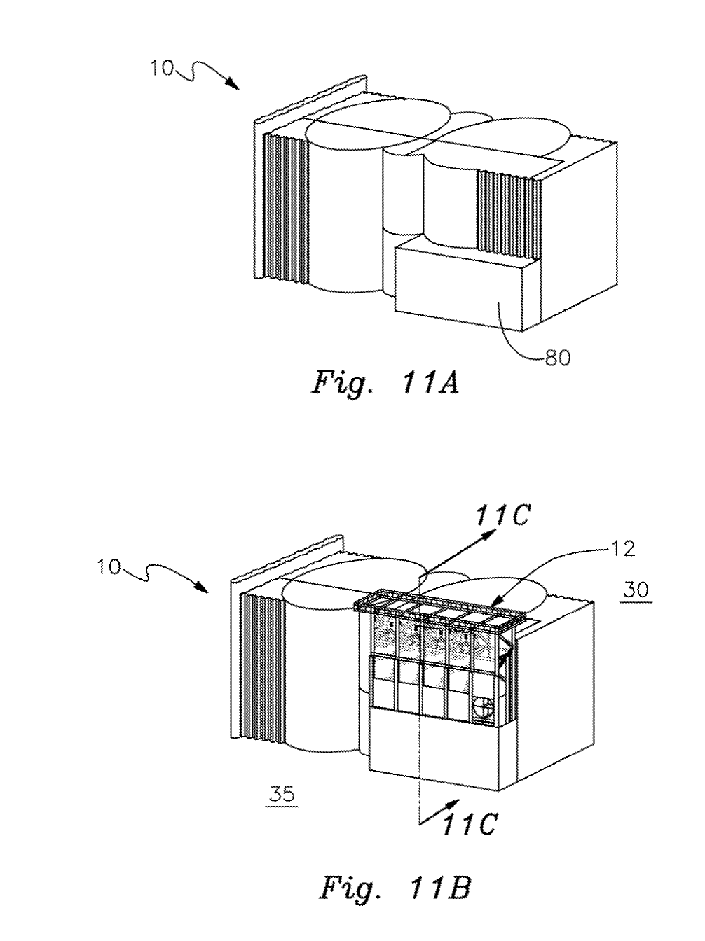

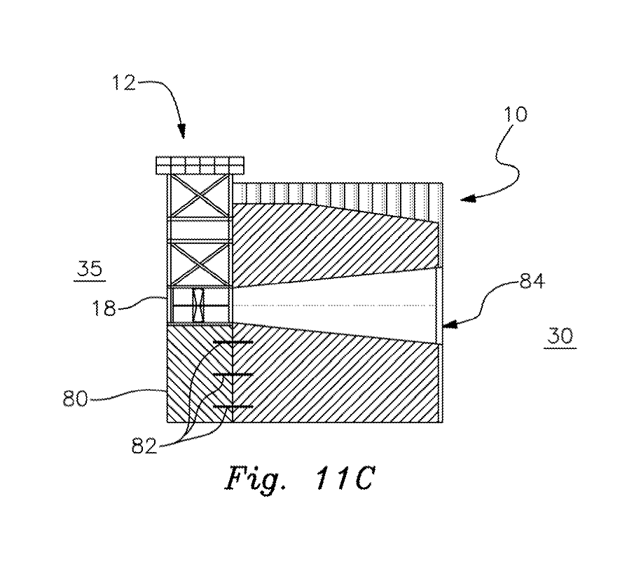

Turning now to FIGS. 11A, 11B and 11C, there is shown an alternative embodiment of the invention. FIG. 11A shows a perspective view from an upper pool 35 of a dam 10 with an inserted power generating frame 12 with stackable cells 14 according to a preferred embodiment of the invention. Frame 12 as shown in FIG. 1 has a plurality of energy producing cells inserted onto a platform 80 that is attached and tied into an existing dam structure. Frame 12 has stackable cells each having turbine modules positioned at the bottom of the frame, each having a moveable door 16 such as a sluice gate that permits water flow across the turbine. The turbines are operably connected to a generator module that sits above the turbine to receive power from the rotating turbine. A superstructure portion of the described herein permits insertion and removal of modules comprising an energy generating cell of a turbine and generator.

FIGS. 11B and 11C show a platform 80 constructed contiguous or near an existing dam. FIG. 11C shows a cross sectional view of FIG. 11B along line 11C-11C. Platform 80 is tied into the existing dam via conventional means including rods dowels 82 positioned in the concrete of platform 80 and inserted next to dam 10. Frame module 12 is positioned in front of draft tube 84 that is cut from the existing dam as previously described. Turbine module 18 is thus placed adjacent to draft tube 84 to permit flow through the turbine from the upper pool side 35 to the lower pool side 30.

Construction of platform 80 may be accomplished without significant change to dam 10 and permits placement of frame module 12 at the site, which frame has been previously constructed and moved into position on platform 80.

This innovative system permits the easy retrofitting of current dam structures and spillways to create power from the head potential present at the existing structure. By cutting or grinding the concrete present in the existing dam or adding a platform adjacent the dam or impoundment, energy producing frames and modules may be supported by the dam without the need to create additional and costly support structures. Draft tubes may be integrated into the existing concrete or supported by existing structures at the dam without the need for expensive new construction.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the issued claims.

1. A power generating system in a dam or impoundment comprising:
a dam or impoundment having a removed section to create a first void for a turbine frame having a plurality of power generating cells comprising a turbine and a generator and a second removed section to create voids for outlet flow from said turbines;
a turbine frame matably inserted in said first void;
said turbines in said frame positioned to permit water flow through said turbines and out said voids for outlet flow;
said turbines operably engaged to a plurality of generators for generating power from the movement of water across said turbines.

2. The power generating system in a dam or impoundment as claimed in claim 1 wherein said voids are saw cut.

3. The power generating frame inserted in a dam or impoundment as claimed in claim 1 wherein said voids are created by grinding action.

4. The power generating system in a dam or impoundment as claimed in claim 1 wherein said turbine frame is removable via a gantry on said dam.

5. The power generating system in a dam or impoundment as claimed in claim 1 further comprising one or more sluice gates on said frame blocking flow through said turbines.

6. The power generating system in a dam or impoundment as claimed in claim 1 further comprising draft tubes associated with each of said voids for outlet flow.

7. The power generating system in a dam or impoundment as claimed in claim 1 further comprising generally circular inlet openings in said voids for outlet flow.

8. The power generating system in a dam or impoundment as claimed in claim 1 further comprising generally pyramidal, oval or circular outlet opening in said voids for outlet flow.

9. A method for retrofitting a dam or impoundment with a power generating frame comprising:
removing a section of a dam or impoundment having an upper and lower dam pool to create a first void for a turbine frame having a plurality of power generating cells each comprising a turbine and a generator;
removing a second section to create voids for outlet flow from said turbines;
inserting a turbine frame in said first void;
wherein water from said upper dam pool flows across said turbine and exits through said void for outlet flows in said lower dam pool thereby turning said turbine; and
generating power from each of said turbines by engaging each of said generators in said cells.

10. The method for retrofitting a dam or impoundment with a power generating frame as claimed in claim 8 further comprising the step of saw cutting said voids.

11. The method for retrofitting a dam or impoundment with a power generating frame s claimed in claim 8 further comprising the step of grinding out said voids.

12. The method for retrofitting a dam or impoundment with a power generating frame as claimed in claim 8 further comprising the step of shaping pyramidal openings in said voids for outlet flow.

13. A power generating system in a dam or impoundment comprising:
a base integrated into a dam or impoundment for placement of a turbine frame having a plurality of power generating cells comprising a turbine and a generator;
a turbine frame matably inserted on said base;
draft tubes matably attached to said frame corresponding to each power generating cell;
said turbines in said frame positioned to permit water flow through said turbines and out said draft tubes for outlet flow;
said turbines operably engaged to a plurality of generators for generating power from the movement of water across said turbines.

14. The power generating system in a dam or impoundment as claimed in claim 11 wherein said base is tied into said dam or impoundment with connecting bars or dowels.

15. The power generating system in a dam or impoundment as claimed in claim 11 wherein draft tubes are cut into said dam or impoundment.

16. The power generating system in a dam or impoundment as claimed in claim 11 wherein said draft tubes re generally frustoconical.

17. The power generating system in a dam or impoundment as claimed in claim 11 wherein said draft tubes are mounted on the dam and positioned below the water level in a lower downstream dam pool.

18. The power generating system in a dam or impoundment as claimed in claim 11 further comprising a sluice gate in front of each turbine.

19. The power generating system n a dam or impoundment where draft tubes are from the dam or impoundment.

20. A power generating system in a dam, or impoundment comprising:
a base integrated into a dam or impoundment for placement of a turbine frame having a plurality of power generating cells comprising a turbine and a generator;
a turbine frame matably inserted on said base;
draft tubes matably attached to said frame corresponding to each power generating cell;said turbines n said frame positioned to permit water flow through said turbines and out said draft tubes for outlet flow; and
said turbines operably engaged to a plurality of generators for generating power from the movement of water across said turbines.

21. The power generating system in a dam or impoundment as claimed in claim 20 wherein said base is created by cutting the top section of a weir of the dam
